(19) United States
(12) Patent Application Publication
(10) Pub. No.: US 2017/0272181 A1
(43) Pub. Date: Sep. 21, 2017

(54) POSITIONING METHOD AND SYSTEM BASED ON WIRELESS SIGNALS

(71) Applicants: Manoj Gudi, Thane District (IN); Prateek Chaturvedi, Thane (IN)

(72) Inventors: Manoj Gudi, Thane District (IN); Prateek Chaturvedi, Thane (IN)

(21) Appl. No.: 15/528,516

(22) PCT Filed: Nov. 16, 2015
(86) PCT No.: PCT/IB2015/058838

§ 371 Date: May 21, 2017

(30) Foreign Application Priority Data
Nov. 24, 2014 (IN) 3718/MUM/2014

(51) Int. Cl. H04B 17/27; H04W 64/00; H04L 29/08; G01S 5/02

(52) U.S. Cl. CPC H04B 17/27; G01S 5/0294; H04W 64/003; H04L 29/08657

(57) ABSTRACT

A method and system for positioning a mobile device in a predefined space using wireless signals transmitted by access points is disclosed. In an initial mapping stage, the predefined space is mapped to study the signal characteristics of positions in that space. Positions in the predefined space that are close to and receive signals from the same access points and have similar signal characteristics are grouped into clusters. Positioning of a mobile device in the predefined space is carried out in two stages. In the first positioning stage, the mobile device is assigned to one of the clusters. In a second positioning stage, the position of the mobile device is determined by applying a prediction method assuming that the assigned cluster is the new universe. Data from INS (Inertial Navigation System) sensors like accelerometers, gyroscopes and magnetometers are used to further refine the position.

### FIELD OF THE INVENTION

The present disclosure relates to the field of positioning systems. More particularly, the present disclosure relates to positioning methods and systems based on wireless signals.

### BACKGROUND

The background description includes information that may be useful in understanding the present disclosure. It is not an admission that any of the information provided herein is prior art or relevant to the presently claimed invention, or that any publication specifically or implicitly referenced is prior art.

There exists technology for sending and receiving wireless signals within predefined spaces. These include Bluetooth based WiFi Routers, iBeacons, A-GPS, mobile devices and other computing and communication devices.

On the other hand, in places such as malls, stores and other public spaces there is a need to accurately determine the position of people, vehicles and items carrying a mobile device, which can help provide relevant information and services to the users.

Positioning technologies are known in the prior art, however there is a need for improvement in terms of accuracy, speed, and resources required.

The present disclosure in its various aspects and embodiments provides systems and methods for positioning a mobile device accurately and quickly using lesser resources.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### Objects of the Invention

Some of the objects of the present invention, which at least one embodiment herein satisfies are as follows:

An object of the present disclosure is to provide a method for positioning a mobile device within a predefined space.

One more object of the present disclosure is to provide a positioning system which is spectrum agnostic—i.e., a system that works in all radio frequencies.

One more object of the present disclosure is to utilize existing wireless infrastructure and to integrate Inertial Navigation System (INS) sensors of a mobile device to improve positioning accuracy.

Another object of the present disclosure is to provide a method and system for positioning which requires less system and processing resources, is faster and is more accurate.

Yet another object of the present disclosure is to provide a simple and reliable method and system for positioning a mobile device within a predefined space.

### SUMMARY

The present disclosure relates to the field of positioning systems. More particularly, the present disclosure relates to positioning methods and systems based on wireless signals.

In an aspect, the present disclosure relates to a system that can be configured to determine position of a mobile device in a defined space, said system having a mobile signal information receive module that can be configured to receive, at a computing device, from the mobile device, signal information pertaining to the mobile device, wherein said signal information is generated based on attributes of signals received by the mobile device from one or more communicatively coupled access points; a comparison module that can be configured to, at the computing device, compare the mobile device signal information with stored signal information of one or more clusters, wherein each cluster represents a physical region within the defined space in which region all positions have same or similar signal information characteristics; and an assignment module configured to, at the computing device, assign the mobile device to a cluster of the one or more clusters based on the comparison output, wherein mobile device signal information is closest to the signal information of the assigned cluster when compared to signal information of other clusters, and wherein the assigned cluster indicates the location of the mobile device.

In an aspect, the signal information of a cluster can be computed based on assessment of any or a combination of strength of signals received from one or more access points at at-least one position in the cluster, number of access points from which signals are received, attributes of signals received from one or more access points, SSID of access points from which signals are received, frequency of signal reception, mean value of signals received from access points, and standard deviation of the signals received from access points.

In another aspect, the computing device can be a server, and wherein the stored signal information of one or more clusters can be stored in a database that can be operatively coupled with the server. In another aspect, the one or more clusters can be created by recording, for one or more positions in the predefined space, signal characteristics of wireless signals received at that position from the one or more access points, and grouping the one or more positions in the predefined space that are close to or receive signals from common access points or have similar signal characteristics into the one or more clusters.

In yet another aspect, the system can further include a determination module that can be configured to determine exact location of the mobile device by applying a prediction technique. The prediction technique can use the one or more access points and/or wireless signals information relating to the respective cluster. The prediction technique can further be selected from one or a combination of fingerprinting, filtering, Linear Kalman Filter, Fingerprinting Kalman Filter based prediction, Extended Kalman Filter based prediction, Maximum likelihood technique based prediction, Markov Localization based prediction, Fuzzy logic based WiFi Fuzzifier based prediction, Prediction Algorithm that predicts where the mobile device is by analyzing and scoring characteristics of clusters obtained from refined training data and readings of the mobile device, Neural Network based classifier based prediction, recursive classification technique based prediction, Hidden Markov Model based prediction, and Radial Basis Function based neural network classifier based prediction.

In an aspect, the present disclosure further relates to a method for determining position of a mobile device in a defined space, said method including the steps of receiving, at a computing device, from the mobile device, signal information pertaining to the mobile device, wherein said signal information is generated based on attributes of signals received by the mobile device from one or more communicatively coupled access points; comparing, at the computing device, the mobile device signal information with stored signal information of one or more clusters, wherein each cluster represents a physical region within the defined space in which region all positions have same or similar signal information characteristics; and assigning, at the computing device, the mobile device to a cluster of the one or more clusters based on the comparison output, wherein mobile device signal information is closest to the signal information of the assigned cluster when compared to signal information of other clusters.

### BRIEF DESCRIPTION OF THE ACCOMPANYING DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The method and system for a positioning based on wireless signals, in accordance with the present disclosure, will now be described with the help of the accompanying drawings, in which:

FIG. 1 illustrates an exemplary network architecture of the proposed mobile device position determination system in accordance with an embodiment of the present disclosure.

FIG. 2 illustrates exemplary functional modules of the present mobile device location determination system in accordance with an embodiment of the present disclosure.

FIG. 3 is an exemplary flow diagram illustrating the main steps for dividing the predefined space into clusters in accordance with an embodiment of the present disclosure; and

FIG. 4 is a flow diagram illustrating the main steps for positioning the mobile device in the predefined space in accordance with an embodiment of the present disclosure.

### DETAILED DESCRIPTION

### Definitions

The terms used throughout this specification are defined as follows, unless otherwise limited in specific instances:

The expression “predefined space” used hereinafter in the specification refers to a space within which location of a device has to be determined. In this specification, the predefined space may also be referred to as “universe”. The predefined space may be enclosed (e.g., in an Indoor Mall or Store) and may also be referred to as “enclosed space” in this specification.

The expression “mobile device” used hereinafter in the specification refers to the device whose position has to be determined within the predefined space. The mobile device may be carried by a person or may be attached to a cart, vehicle or other movable item. The mobile device can be any portable device and would generally have the ability to receive and send signals. The mobile device may also be referred to as “user device” or “live device” in this specification. In an aspect, the mobile device can include one or more sensors required for positioning (including but not limited to WiFi/BT receivers and IMU sensors)

The expression “access point” used hereinafter in the specification refers to wireless signal transmitters that can send and receive wireless signals. Access points may also have the ability to communicate with other nearby or far off computing or communication devices through wired or wireless signals.

In an aspect, methods and systems for a positioning based on wireless signals in accordance with the present disclosure will now be described with reference to exemplary embodiments shown in the accompanying drawing. The exemplary embodiments are explained particularly with reference to a positioning method and system based on wireless signals.

In accordance with one aspect of this disclosure, there is provided a method for determining location of a mobile device (and/or user associated therewith) (such as of a mobile phone, smart phone, tablet, or any other computing device associated with a user/vehicle, for instance) in a predefined space based on wireless signals from access points (APs). In an aspect, the method can be implemented in a computing device and/or in a server. In an aspect, the method can include the step of receiving, at the computing device/server, access point wireless signal information from the mobile device that is operatively coupled with the computing device/server, wherein the access point wireless signals can be detected on the mobile device. In an aspect, the mobile device can be communicatively coupled with a plurality of APs that can keep sending wireless signals to the mobile device such that based on different signals received from the APs that are in range of the mobile device, a wireless signal information can be determined/computed, and accordingly sent to the computing device/server. Such wireless signal information can be perceived as a signal fingerprint/signature that is unique to the mobile device in context.

The method of the present disclosure can further include the step of retrieving previously stored wireless signals information relating to one or more clusters, wherein the clusters can be created by dividing the predefined space based on:
i) recording, for various positions in the predefined space, signal characteristics such as signal strengths of the wireless signals received at that position from the access points, and
ii) grouping positions in the predefined space that are close to or receive signals from the same access points and have similar signal characteristics into a plurality of clusters.

In an aspect therefore, for a building such as a mall, for various positions/locations in the mall, signal characteristics such as signal strengths can be determined at such positions with respect to one or more APs that are communicatively accessible at the respective positions. Based on the computed signal characteristics, a signal signature/fingerprint can be generated that is unique to a group of positions/locations, wherein such a group is referred to as a cluster. For instance, in a mall, 40 clusters can be formed, each depicting an area where the signature characteristics such as signal strength/parameter/attribute are same/similar.

In an aspect, method of the present disclosure can further include the steps of comparing wireless signal information detected on the mobile device with the previously stored wireless signals information relating to the one or more clusters; and assigning the mobile device to a corresponding cluster, wherein the corresponding cluster is a cluster whose signal characteristics/signatures/attributes/parameters are closest to the wireless signal information detected on the mobile device; and determining the location of the mobile device by applying a prediction method that uses particular access points and wireless signals information relating to the corresponding cluster.

In an aspect, positions in the predefined space, referred to above, are, generally, points where signals from multiple access points gravitate towards and generate a stronger reading. Such points may be referred to as raw points.

Further, the strength of signals from access points can be used to determine a value that can be referred to as mravity value, for each raw point. Mravity value of a physical position (such as a raw point) can provide a measure of a correlation between that physical position and all other positions in the universe (predefined space) with reference to signal strength of access points. The raw point with the highest mravity value can be designated as a seed point as the raw points in the vicinity gravitate towards the seed.

Further, grouping positions in the predefined space into a cluster, referred to above, can be done by grouping raw points whose mravity value is very close to mravity value of the seed point. Therefore, positions having commonality in terms of access points from which signals are received and signal characteristics can be grouped into one cluster.

Furthermore, wireless signals information, referred to above, can include one or more of, names and IDs of access points from which signals are received, strengths of the signals, frequencies of the signals, or any other information that can help identify, quantify or classify the signals.

Additionally, signal characteristics, referred to above, can include signal frequencies.

In an aspect, the prediction method, referred to above, can include, but is not limited to, fingerprinting, filtering, or other methods for determining location of the mobile device. Some exemplary prediction techniques/methods that may be employed include Fingerprinting Kalman Filter, Extended Kalman Filter and its applicable/suitable variants, Maximum likelihood techniques such as Markov Localization, Fuzzy logic based WiFi Fuzzifier, Prediction Algorithm that predicts where the live device is by analyzing and scoring characteristics of clusters obtained from refined training data and readings of live device, Neural Network based classifier, Algorithms which use recursive classification technique, Hidden Markov Model based algorithm, and Radial Basis Function based neural network classifier.

Additionally, parameters obtained from Inertial Navigation System (INS) sensor data (such as acceleration obtained from accelerometers, and velocity inferred from acceleration, heading direction from magnetometers, and orientation from gyroscopes) can be used to correct the position and eliminate false positives from multiple positions for the mobile device.

In an aspect, access point wireless signals information from the mobile device, referred to above, can be received by receivers connected to one or more computing devices for processing the information. The access points can also serve as the receivers.

In an aspect, the computing device, referred to above, can include one or more components to enable processing, storage and communication of information.

In an aspect of the present disclosure, the cluster information along with their respective signal information/signature can be stored in a server that can be operatively coupled with the mobile device to receive signal information/attribute of the mobile phone and compare the same with the signal information of the one or more clusters to identify the physical cluster to which the device pertains.

In accordance with another aspect of this disclosure, there is provided a method for dividing a predefined space into smaller clusters such that the clusters and information relating to the clusters can be used to determine location of a mobile device in a predefined space based on wireless signals from access points using at least one computing device, wherein the method can include dividing the predefined space into clusters by,
i) recording, for various positions in the predefined space, the signal characteristics, such as signal strengths, of the wireless signals received at that position from the access points, and
ii) grouping positions in the predefined space which are close to or receive signals from the same access points and have similar signal characteristics into a plurality of clusters; and
   The method can further include storing the wireless signals information relating to each cluster such that these can be used for positioning a mobile device in the predefined space.

In accordance with yet another aspect of this disclosure, there is provided a system for determining location of a mobile device in a predefined space based on wireless signals from access points and using at least one computing device, wherein the system can include a receiving module that can be configured to receive access point wireless signals information from the mobile device, wherein said access point wireless signals have been detected on the mobile device. System of the present disclosure can further include a retrieving module that can be configured to retrieve previously stored wireless signals information relating to clusters, wherein the clusters have been created by dividing a predefined space in the following manner,
i) recording, for various positions in the predefined space, the signal characteristics, such as signal strengths, of the wireless signals received at that position from the access points, and
ii) grouping positions in the predefined space which are close to or receive signals from the same access points and have similar signal characteristics into a plurality of clusters;
   System of the present disclosure can further include a comparison module that can be configured to compare access point wireless signals information detected on the mobile device with the previously stored wireless signals information relating to clusters; an assignment module that can be configured to assign the mobile device to a corresponding cluster, wherein the corresponding cluster is a cluster whose signal characteristics are closest to the access point wireless signals detected on the mobile device; and a determination module that can be configured to determine the location of the mobile device by applying a prediction method that uses the access points and wireless signals information relating to the corresponding cluster.

In accordance with yet another aspect of the present disclosure, there is provided a system for dividing a predefined space into smaller clusters such that the clusters and information relating to the clusters can be used to determine the location of a mobile device in the predefined space based on wireless signals from access points using at least one computing device, wherein the system can include a division module that can be configured to divide the predefined space into clusters by,
i) recording, for various positions in the predefined space, the signal characteristics, such as signal strengths, of the wireless signals received at that position from the access points, and
ii) grouping positions in the predefined space which are close to or receive signals from the same access points and have similar signal characteristics into a plurality of clusters.
   System of the present disclosure can further include a storage module that can be configured to store the wireless signals information relating to each cluster such that these can be used for positioning a mobile device in the predefined space.

In an aspect, the positioning system and method can be implemented using any computing or communication devices such as but not limited to PCs, servers, laptops, notebook computers, tablets, mobile phones, or smart phones whether in standalone mode or connected to other devices.

In one embodiment, the system as described herein above may be implemented as a computer program product tangibly implemented on a machine-readable media.

The expression ‘machine readable media’ used herein refers to RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor.

The expression ‘computer program product’ is defined as a manufactured product embodied in a machine-readable medium as defined herein above.

The present disclosure relates to a method and system for positioning a mobile device in a predefined space using wireless signals transmitted by access points.

In an initial mapping stage, a predefined space can be mapped to study the signal characteristics of positions in that space. For various positions in the predefined space, the signal characteristics (such as access point names, signal strengths and frequency) of the signals received from the access points can be recorded, wherein this process is called as mapping and the data recorded is called as training data.

Positions in the predefined space that are close to and receive signals from the same access points and have similar signal characteristics can be grouped into clusters, and therefore the predefined space gets divided into smaller clusters based on commonality of access points and signal characteristics.

In an aspect, positioning of a mobile device in the predefined space can be carried out in two stages, wherein in a first positioning stage, the mobile device can be assigned to one of the clusters by comparing signal characteristics of the signal received on the mobile device with signal characteristics of the clusters and determining the cluster with signal characteristics closest to the signals received on mobile device. The cluster with the closest signal characteristics has a very high probability of containing the mobile device. In a second positioning stage, the position of the mobile device can be determined by applying a prediction method assuming that the assigned cluster is the new universe. Thus, access points and signal data relating to that cluster can be used by the prediction method, which significantly reduces the errors, complexity, and amount of processing involved in locating the position of the mobile device.

Additionally, in the second positioning stage, parameters obtained from Inertial Navigation System (INS) sensor data (like acceleration obtained from accelerometers, and velocity inferred from acceleration, the heading direction from magnetometers and the orientation from gyroscopes) can help correct the position and eliminate false positives from multiple positions for the mobile device.

The exemplary embodiments of the present disclosure are described in greater detail hereafter with reference to the accompanying exemplary drawings.

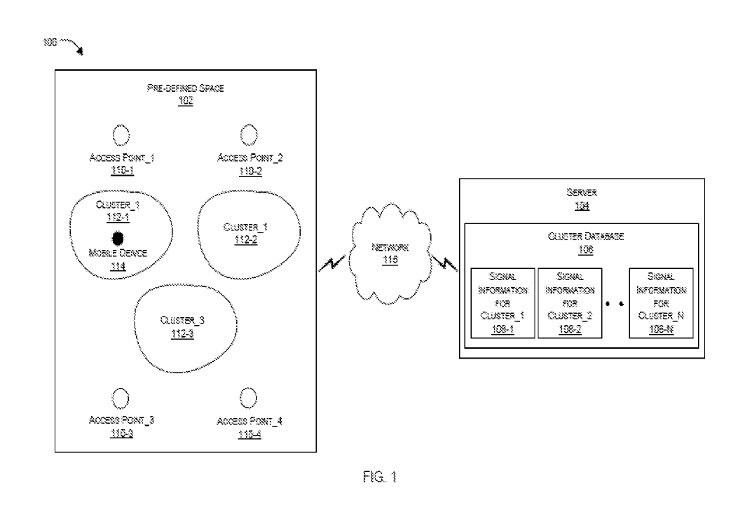

FIG. 1 illustrates an exemplary network architecture 100 of the proposed mobile device position determination system in accordance with an embodiment of the present disclosure. As shown, the architecture can include a pre-defined space/area 102 that can include one or more access points (APs) 110 for providing network connectivity to associated mobile devices such as 114 (such as mobile phone, tablet PC, among other like computing devices). In an aspect, the computing device 114 can be operatively coupled with a server/cloud 104 through a network 114, for instance a secured network.

In an embodiment, user having the mobile device 114 can move from one location in the pre-defined space/area 102 to another location (say from one store in a mall to another store), and therefore in order to compute the exact position of the mobile device 114, signal information such as signal strength that the mobile device receives from one or more APs such as 110-1, 110-2, 110-3, and 110-4 can be computed/collected at the device 114 and transmitted over the network 114 to the server 104. In an aspect, the signal information can be processed before sending to compute a secured/encrypted signature of the signal information.

In an aspect, when the server 104 receives the mobile device signal information, it retrieves the stored signal information 108 pertaining to one or more clusters from a cluster database 106, and matches the mobile device signal information with the one or more signal information 108 of clusters to identify the closest signal information match. For instance, each cluster's signal information 108 can have a defined/unique signature/attribute that can be computed based on signal strength that is received from one or more APs 110 that are accessible at the respective cluster location. Once a match is found, location of the mobile device 114 can be determined as the cluster whose signal information matches closest with the signal information of the mobile device's signal information. For instance, in the present instance, mobile device 114 can be identified to be in cluster 112-1 from among other clusters 112-2 and 112-3.

In an aspect, once the cluster 112 in which the mobile device 114 is located is determined, the cluster 112-1 can be taken to be a new universe, and positioning methods or techniques can be applied using access points and signal data relating to that cluster. At this point, data obtained from INS Sensors of the mobile device 114 can be used to help correct the position and eliminate false positives from multiple positions for the mobile device. Thereby the precise position of the mobile device 114 is determined.

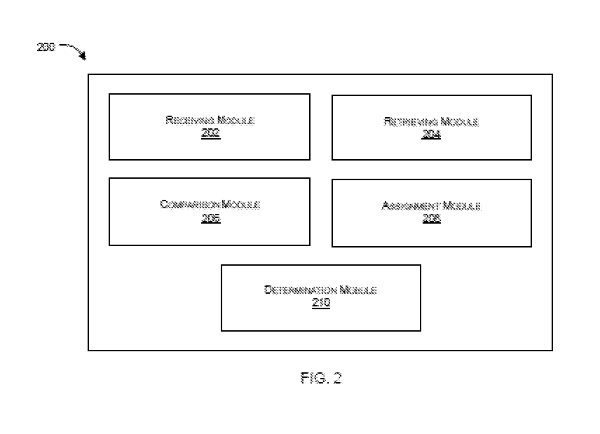

FIG. 2 illustrates exemplary functional modules 200 of the present mobile device location determination system in accordance with an embodiment of the present disclosure. In an aspect, system of the present disclosure can include a receiving module 202 that can be configured to receive access point wireless signals information from the mobile device, wherein said access point wireless signals have been detected on the mobile device. System of the present disclosure can further include a retrieving module 204 that can be configured to retrieve previously stored wireless signals information relating to clusters, wherein the clusters have been created by dividing a predefined space by recording, for various positions in the predefined space, the signal characteristics, such as signal strengths, of the wireless signals received at that position from the access points; and grouping positions in the predefined space which are close to or receive signals from the same access points and have similar signal characteristics into a plurality of clusters.

System of the present disclosure can further include a comparison module 206 that can be configured to compare access point wireless signals information detected on the mobile device with the previously stored wireless signals information relating to clusters; an assignment module 208 that can be configured to assign the mobile device to a corresponding cluster, wherein the corresponding cluster is a cluster whose signal characteristics are closest to the access point wireless signals detected on the mobile device; and a determination module 210 that can be configured to determine the location of the mobile device by applying a prediction technique that uses the access points and wireless signals information relating to the corresponding cluster.

In accordance with yet another aspect of the present disclosure, there is provided a system for dividing a predefined space into smaller clusters such that the clusters and information relating to the clusters can be used to determine the location of a mobile device in the predefined space based on wireless signals from access points using at least one computing device, wherein the system can include a division module that can be configured to divide the predefined space into clusters by recording, for various positions in the predefined space, the signal characteristics, such as signal strengths, of the wireless signals received at that position from the access points; and grouping positions in the predefined space which are close to or receive signals from the same access points and have similar signal characteristics into a plurality of clusters.

System of the present disclosure can further include a storage module that can be configured to store the wireless signals information relating to each cluster such that these can be used for positioning a mobile device in the predefined space.

In an exemplary aspect, Wi-Fi signals tend to be very erratic and fluctuate both temporally and spatially. The signal strengths at just one location can vary by as much as 15-30%. Thus, in order to use any fingerprinting technique, one needs to account for temporal variation at that location, which amounts to defining a range of signal strength, which is empirically learnt to be primarily dependent on the temporal mean of the Wi-Fi signal. This range is in linear relationship with temporal mean, and sets a lower bound for the live signal. If live signal's strength is observed to be out of bounds, that particular access point can be disregarded for that location. This method helps to reduce the prediction of false positives.

In another exemplary aspect, mapping generates a database of all the visible access points along with their characteristics at all the mapped locations. Post-mapping analysis can include generating the following 2 types of characteristics—How are the characteristics of a particular access point in all the locations mapped in a particular cluster of mapped locations, and how are the characteristics of all the access points at a particular location found at all the locations. The characteristics can include the following—The visibility factor (measure of how frequently a particular access point is seen in all the mapping scans taken), distinguishability factor (measure of statistically how distinguishable is the signal strength distribution of multiple access points), mappability factor (number of quality access points at a particular location), service set identification (SSID), basic service set identification (BSSID), mean value of a signal during mapping, standard deviation of the signal during mapping, histogram, number of useful access points at a particular location for all the locations, number of the locations at which a particular access point is seen, ranges of signal strength observed at all the locations in the location cluster, among other like parameters. These parameters can be used in deciding the locations and the access points, which have favorable values of the above parameters. If a particular location is apposite in this regard, it can be associated with one or more access points along with their range of signal strengths. This is referred to as tagging. Once the tagging is done, during prediction phase, whenever a live signal is received, it can be compared to these tags such that if a conditioned live signal falls belongs to a particular tagged data, the associated location is published as the prediction.

In yet another aspect, Organizationally Unique Identifiers (OUI) can be used for filtering out mobile access points in indoor localization using Wi-Fi. In an aspect, an Organizationally Unique Identifier (OUI) is a 24-bit number that can uniquely identifies a vendor, manufacturer, or other organization globally or worldwide purchased from the Institute of Electrical and Electronics Engineers, Incorporated (IEEE) Registration Authority. The database of OUI can be made publically available by IEEE online. The basic service set identification (bssid) of a Wi-Fi access point can be recorded during the mapping phase at a location. The first 24 bits of this corresponds to the OUI of the manufacturer. In the localization using Wi-Fi, at the mapping stage, all the visible access points can be recorded, which can also include rogue ones that do not feature in OUI database. There is an almost certainty of the rogue access points being mobile access points, which entails that one should not use these routers while prediction since these are very likely to not be fixed to a particular location. By checking if a given bssid's first 24 bits does not exist in OUI database, the access point can be disregarded from the all further prediction processes.

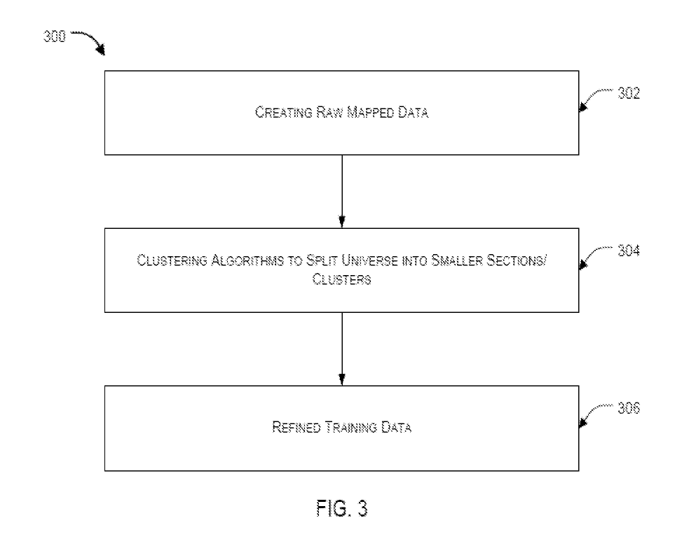

FIG. 3 is a flow diagram 300 illustrating the main steps of a mapping stage, wherein wireless signal information is collected and predefined space is divided into clusters. Wireless signals received at various positions (raw points) within the predefined space from access points in vicinity can be detected and stored thereby creating raw mapped data 302. Clustering methods can be used to split the universe (i.e., predefined space) into smaller clusters 304, wherein the raw mapped data along with the data related to the clusters forms refined training data 306.

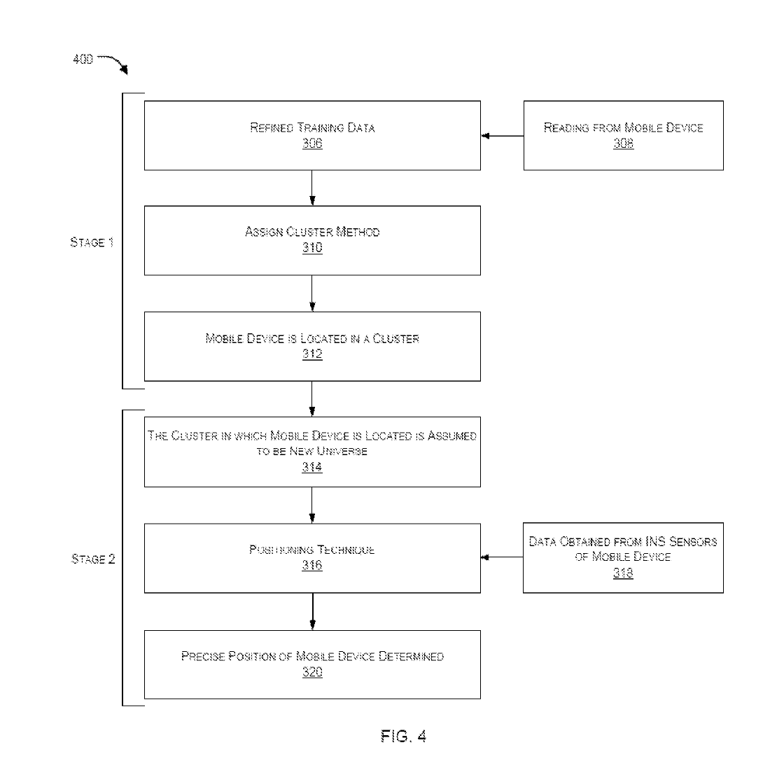

FIG. 4 is a flow chart 400 illustrating the main steps for positioning the mobile device in the predefined space in accordance with an embodiment of the present disclosure. The positioning can be achieved in two stages—i.e., Stage 1 for assigning the mobile device to a cluster, and Stage 2 for determining the precise position of the mobile device within the cluster.

In Stage 1, refined training data 306 relating to the clusters can be compared with readings from the mobile device 308. The mobile device can be assigned 310 to the cluster whose training data (i.e., signal information) is closest to the signal readings from the mobile device. Thereby, the mobile device can be located in a particular cluster 312.

In Stage 2, the cluster in which mobile device is located is assumed to be the new universe 314, and positioning methods or techniques 316 are applied using access points and signal data relating to that cluster. At this point, data obtained from INS Sensors of the mobile device 318 can be used to help correct the position and eliminate false positives from multiple positions for the mobile device. Thereby the precise position of the mobile device is determined 320.

Even though the exemplary description herein refers to WiFi devices and signals, the methods and systems disclosed herein are applicable to all types of devices and signals.

The present invention relates to a method and system for real-time positioning, tracking and navigation of mobile phones using the signal parameters like signal strengths, frequency, it's BSSID/SSID(Service Set Identifier) of emitter devices like routers, or Wi-Fi sticks/gears, Bluetooth beacons, 2g/3g/4g antennas, scanned periodically.

Another aspect of this invention is that unlike other existent positioning system, it uses INS (Inertial Navigation System) sensors like accelerometers, gyroscopes and magnetometers to further refine the positioning of the system.

It uses innovative clustering based algorithm to locate mobile device, and keeps adapting by learning the environment over the time. Moreover, the algorithm and techniques used are spectrum agnostic, that is, they also work in all radio frequencies, including but not limited to WiFi, Bluetooth, Mobile phone networks etc.

WLAN (Wireless Local Area Networks) also known as Wi-Fi, is a ubiquitous wireless technology based on IEEE 802.11 a/b/g protocol used in lot of cities, areas, malls, shops and even homes for internet and data communication. To set up a Wi-Fi connection, you require a Wi-Fi transmitter also called as Access Points (AP)/Wireless network routers which transmit data up to range of 10-150 meters.

Because of the number of Wi-Fi access points that are unique to an area, a Wi-Fi network based positioning can be achieved by a user who has a smart device (like a mobile phone) enabled with Wi-Fi receiver.

RSSI finger-printing is one of the techniques that can be used to achieve the same. In this technique, the area where positioning is to be achieved can be mapped initially to study the Wi-Fi (i.e., signal) characteristics (signature) of that place. The entire area can be fragmented into smaller areas. It's spatial layout and characteristics such as access point names, access point signal strength, access point frequency etc. can be recorded and studied, which is referred to as mapped, wherein the data recorded is further used to train algorithms, hence they may be called training data. For RSSI finger-printing technique, the size of area (universe) should be finite. The present disclosure deals with problem of assigning to a user device, a position or co-ordinate near to a RSSI point (mapped earlier) that exists in the universe obtained from training data. The problem with this assignment technique is that it yields a lot of inaccurate results if the universe size is large (for example a large mall), which can be addressed by the present invention by reducing the size of the universe by applying clustering techniques. Each universe can be divided into small clusters based on their unique Wi-Fi (i.e., signal) characteristics such as signal strengths and their proximity to a nearby access point, which is illustrated in FIG. 1.

Once this is done, the positioning happens in two stages as illustrated in FIG. 2:

Stage 1. Assigning the live device to one of the cluster by calculating a score based on the Wi-Fi characteristics between all clusters and the reading from live device, and comparing it. The cluster with optimal score has very high probability of containing that device.

Stage 2. The prediction algorithm is now applied assuming that the assigned cluster is the universe, which significantly reduces the errors. The parameters obtained from INS sensor data (like acceleration obtained from accelerometers, and velocity inferred from acceleration, the heading direction from magnetometers and the orientation from gyroscopes) can help correct the position and eliminate false positives from multiple Wi-Fi positions a live device may be in. This technique used is called sensor fusion.

In an exemplary embodiment, the prediction algorithm for positioning the mobile device may employ one or more methods or techniques including but not limited to, Fingerprinting Kalman Filter, Extended Kalman Filter, Maximum likelihood techniques such as Markov Localization, Fuzzy logic based WiFi Fuzzifier, Prediction Algorithm that predicts where the live device is by analyzing and scoring characteristics of clusters obtained from refined training data and readings of live device, Neural Network based classifier, Algorithms which use recursive classification technique, Hidden Markov Model based algorithm, Radial Basis Function based neural network classifier.

In one exemplary embodiment, the proposed system can include one or more of the following physical components:
1. Access points which emit signals and can also receive signals—e.g., Wi-fi router, Bluetooth beacon, A-GPS, radio signal emitter, IR emitter, 2G/3G/4G signal emitter etc.,
2. A user device capable of receiving signals from access points and sending a signal back and, possibly, having INS systems—e.g., a mobile phone, communication device etc., and
3. Control system comprising hardware & software elements for controlling the operation of the system.

### Test Data:

A trial was conducted inside a mall in Mumbai with carpet area of 2000 square feet in April 2014. The mall was mapped for Wi-Fi signals with resolution of 3 ft. Using mravity value algorithm, the mall was subdivided into 6 distinct clusters and around 28 live_readings were tested. The results are divided in 3 groups:
1. Spot-on prediction (Groups where the algorithm was spot on in prediction): 17/28˜60.71%,
2. Predictions in top two (Right cluster was in top two predictions because the point lied just on boundary of two clusters): 7/28=25.0%,
3. Wrong prediction (Where the algorithm completely missed it): 4/28∞14.28%
   The result shows that the algorithm had an accuracy of 8-15 feet with ˜85% confidence level for this trial.

### Alternative Embodiments:

The present method and system is spectrum agnostic. Though the exemplary embodiments herein refer to wireless technology (i.e. spectrum defined by 802.11 a/b/g/n) standard, the methods and system work for other radio waves in other spectrum with varying degree of accuracy.

Some algorithms in the scoring section will work without pre-processing the data (clustering the raw data from points using mravity value algorithm) but with reduced accuracy.

The positioning methods work without INS sensors of the device.

The mapping and clustering stage need not be followed by the positioning stages. It can be used to geofence or find similar spots based on radio signals, once the raw training data is available.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The use of the expression “at least” or “at least one” suggests the use of one or more elements, as the use may be in one of the embodiments to achieve one or more of the desired objects or results.

The numerical values mentioned for the various physical parameters, dimensions or quantities are only approximations and it is envisaged that values higher or lower than the numerical values assigned to the parameters, dimensions or quantities fall within the scope of the disclosure, unless there is a statement in the specification specific to the contrary.

Wherever a range of values is specified, a value up to 10% below and above the lowest and highest numerical value respectively, of the specified range, is included in the scope of the disclosure.

The process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously, in parallel, or concurrently.

The aim of this specification is to describe the invention without limiting the invention to any one embodiment or specific collection of features. Person skilled in the relevant art may realize the variations from the specific embodiments that will nonetheless fall within the scope of the invention.

It may be appreciated that various other modifications and changes may be made to the embodiment described without departing from the spirit and scope of the invention.

### Advantages of the Invention

The present disclosure provides a system and method that is spectrum agnostic and can be utilized in entire wireless radio-wave spectrum with varying degree of accuracy.

The present disclosure provides a system and method that utilizes existing Wireless infrastructure, and integrates INS sensors of device to improve prediction of position.

The present disclosure provides a system and method that involves a pre-processing step of mapping data that makes the technology faster and more accurate.

The present disclosure has multiple applications including but not limited to indoor positioning of mobile phones or users, indoor positioning of various types of objects such as trolleys, carts, medical equipment, trucks etc. based on readings received from a receiver planted on the device, and finding where someone is and targeting them with services, guidance etc.

We claim:

1. A system configured to determine position of a mobile device in a defined space, said system comprising:
a mobile signal information receive module configured to receive, at a computing device, from the mobile device, signal information pertaining to the mobile device, wherein said signal information is generated based on attributes of signals received by the mobile device from one or more communicatively coupled access points;
a comparison module configured to, at the computing device, compare the mobile device signal information with stored signal information of one or more clusters, wherein each cluster represents a physical region within the defined space in which region all positions have same or similar signal information characteristics; and
an assignment module configured to, at the computing device, assign the mobile device to a cluster of the one or more clusters based on the comparison output, wherein mobile device signal information is closest to the signal information of the assigned cluster when compared to signal information of other clusters, and wherein the assigned cluster indicates the location of the mobile device.

2. The system of claim 1, wherein the signal information of a cluster is computed based on assessment of any or a combination of strength of signals received from one or more access points at at-least one position in the cluster, number of access points from which signals are received, attributes of signals received from one or more access points, BSSID/SSID of access points from which signals are received, frequency of signal reception, mean value of signals received from access points, and standard deviation of the signals received from access points.

3. The system of claim 1, wherein the computing device is a server, and wherein the stored signal information of one or more clusters is stored in a database that is operatively coupled with the server.

4. The system of claim 1, wherein the one or more clusters are created by recording, for one or more positions in the predefined space, signal characteristics of wireless signals received at that position from the one or more access points, and grouping the one or more positions in the predefined space that are close to or receive signals from common access points or have similar signal characteristics into the one or more clusters.

5. The system of claim 1, wherein the system further comprises a determination module configured to determine exact location of the mobile device by applying a prediction technique.

6. The system of claim 5, wherein the prediction technique uses the one or more access points and/or wireless signals information relating to the respective cluster.

7. The system of claim 5, wherein the prediction technique is selected from one or a combination of fingerprinting, filtering, Fingerprinting Kalman Filter based prediction, Extended Kalman Filter based prediction, Maximum likelihood technique based prediction, Markov Localization based prediction, Fuzzy logic based WiFi Fuzzifier based prediction, Prediction Algorithm that predicts where the mobile device is by analyzing and scoring characteristics of clusters obtained from refined training data and readings of the mobile device, Neural Network based classifier based prediction, recursive classification technique based prediction, Hidden Markov Model based prediction, and Radial Basis Function based neural network classifier based prediction.

8. A method for determining position of a mobile device in a defined space, said method comprising the steps of:
receiving, at a computing device, from the mobile device, signal information pertaining to the mobile device, wherein said signal information is generated based on attributes of signals received by the mobile device from one or more communicatively coupled access points;
comparing, at the computing device, the mobile device signal information with stored signal information of one or more clusters, wherein each cluster represents a physical region within the defined space in which region all positions have same or similar signal information characteristics; and
assigning, at the computing device, the mobile device to a cluster of the one or more clusters based on the comparison output, wherein mobile device signal information is closest to the signal information of the assigned cluster when compared to signal information of other clusters.

9. The method of claim 8, wherein the signal information of a cluster is computed based on assessment of any or a combination of strength of signals received from one or more access points at at-least one position in the cluster, number of access points from which signals are received, attributes of signals received from one or more access points, SSID of access points from which signals are received, frequency of signal reception, mean value of signals received from access points, and standard deviation of the signals received from access points.

10. The method of claim 8, wherein the computing device is a server, and wherein the stored signal information of one or more clusters is stored in a database that is operatively coupled with the server.

11. The method of claim 8, wherein the one or more clusters are created by recording, for one or more positions in the predefined space, signal characteristics of wireless signals received at that position from the one or more access points, and grouping the one or more positions in the predefined space that are close to or receive signals from common access points or have similar signal characteristics into the one or more clusters.

12. The method of claim 8, wherein the method further comprises the step of determining exact location of the mobile device based on one or a combination of Inertial Navigation System (INS) sensors.

13. The method of claim 8, wherein the method further comprises the step of determining exact location of the mobile device by applying a prediction technique.

14. The method of claim 13, wherein the prediction technique is selected from one or a combination of fingerprinting, filtering, Fingerprinting Kalman Filter based prediction, Extended Kalman Filter based prediction, Maximum likelihood technique based prediction, Markov Localization based prediction, Fuzzy logic based WiFi Fuzzifier based prediction, Prediction Algorithm that predicts where the mobile device is by analyzing and scoring characteristics of clusters obtained from refined training data and readings of the mobile device, Neural Network based classifier based prediction, recursive classification technique based prediction, Hidden Markov Model based prediction, and Radial Basis Function based neural network classifier based prediction.
